(19) United States
(12) Patent Application Publication
(10) Pub. No.: US 2020/0360958 A1
(43) Pub. Date: Nov. 19, 2020

(54) MIST GENERATOR AND FILM FORMATION APPARATUS

(71) Applicants: Tatsuji NAGAOKA, Nagakute-shi (JP); Hiroyuki NISHINAKA, Kyoto-shi (JP); Masahiro YOSHIMOTO, Kyoto-shi (JP); Daisuke TAHARA, Kyoto-shi (JP)

(72) Inventors: Tatsuji NAGAOKA, Nagakute-shi (JP); Hiroyuki NISHINAKA, Kyoto-shi (JP); Masahiro YOSHIMOTO, Kyoto-shi (JP); Daisuke TAHARA, Kyoto-shi (JP)

(73) Assignees: TOYOTA JIDOSHA KABUSHIKI KAISHA, Toyota-shi (JP); NATIONAL UNIVERSITY CORPORATION KYOTO INSTITUTE OF TECHNOLOGY, Kyoto-shi (JP)

(21) Appl. No.: 16/865,840

(22) Filed: May 4, 2020

(30) Foreign Application Priority Data
May 15, 2019 (JP) 2019-092444

(51) Int. Cl. B05B 17/06

(52) U.S. Cl. CPC B05B 17/0615; B05B 17/0653

(57) ABSTRACT

A mist generator may include a reservoir storing a solution, an ultrasonic vibrator configured to apply ultrasonic vibration to the solution stored in the reservoir to generate mist of the solution in the reservoir, and a mist delivery path configured to deliver the mist from an inside of the reservoir to an outside of the reservoir. A relationship of d≤S^{0.5} may be satisfied, where d is a depth of the solution stored in the reservoir and S is an area of a liquid surface of the solution stored in the reservoir.

### CROSS-REFERENCE TO RELATED APPLICATION

This application claims priority to Japanese Patent Application No. 2019-092444, led on May 15, 2019, the entire contents of which am incorporated herein by reference.

### TECHNICAL FIELD

The disclosure herewith relates to a mist generator and a film formation apparatus.

### BACKGROUND

A mist generator in Japanese Patent Application Publication No. 2016-190172 includes a reservoir storing a solution and an ultrasonic vibrator. The ultrasonic vibrator is configured to apply ultrasonic vibration to the solution stored in the reservoir to generate mist of the solution in the reservoir. The mist of the solution is supplied to an outside of the mist generator via a mist delivery path connected to the reservoir.

### SUMMARY

When the solution stored in the reservoir is atomized, the liquid level of the solution lowers. A concentration of the generated mist becomes stable at a certain height from the liquid surface of the solution. Thus, the lowering in the liquid level varies the height at which the concentration of mist becomes stable. Then, the variations in the height at which the concentration of mist becomes stable vary the concentration of mist to be supplied to the mist delivery path. For this reason, conventional mist generators have difficulty in supplying mist with stable concentration to an outside of the mist generators. The present disclosure provides a technology that enables supply of mist with stable concentration.

A mist generator disclosed herein may comprise a reservoir storing a solution, an ultrasonic vibrator configured to apply ultrasonic vibration to the solution stored in the reservoir to generate mist of the solution in the reservoir, and a mist delivery path configured to deliver the mist from an inside of the reservoir to an outside of the reservoir. A relationship of d≤S^{0.5} may be satisfied, where d is a depth of the solution stored in the reservoir and S is an area of a liquid surface of the solution stored in the reservoir.

In the above-described mist generator, the relationship of d≤S^{0.5} is established between the depth d of the solution and the area S of the liquid surface of the solution. When such a relationship is satisfied, the liquid level of the solution is less likely to vary in response to consumption (i.e., atomization) of the solution. The above-described mist generator therefore can stably generate the mist with a constant concentration at a constant height from the liquid surface of the solution. The mist with stable concentration can thereby be supplied to the outside.

### BRIEF DESCRIPTION OF DRAWINGS

FIG. 1 is a diagram showing a configuration of a film formation apparatus according to a first embodiment.

FIG. 2 is a cross-sectional view of a mist generator (first embodiment) while the mist generator is generating mist of a solution.

FIG. 3 is a cross-sectional view of a mist generator (second embodiment) while the mist generator is generating mist of a solution.

FIG. 4 is a cross-sectional view of a mist generator (third embodiment) while the mist generator is generating mist of a solution.

FIG. 5 is a cross-sectional view of a mist generator (fourth embodiment) while the mist generator is generating mist of a solution.

FIG. 6 is a cross-sectional view of a mist generator (fifth embodiment) while the mist generator is generating mist of a solution.

FIG. 7 is a cross-sectional view of a mist generator (sixth embodiment) while the mist generator is generating mist of a solution.

FIG. 8 is a cross-sectional view of a mist generator (seventh embodiment) while the mist generator is generating mist of a solution.

### DETAILED DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the present disclosure. Furthermore, each of the additional features and teachings disclosed below may be utilized separately or in conjunction with other features and teachings to provide improved mist generators and film formation apparatus, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### First Embodiment

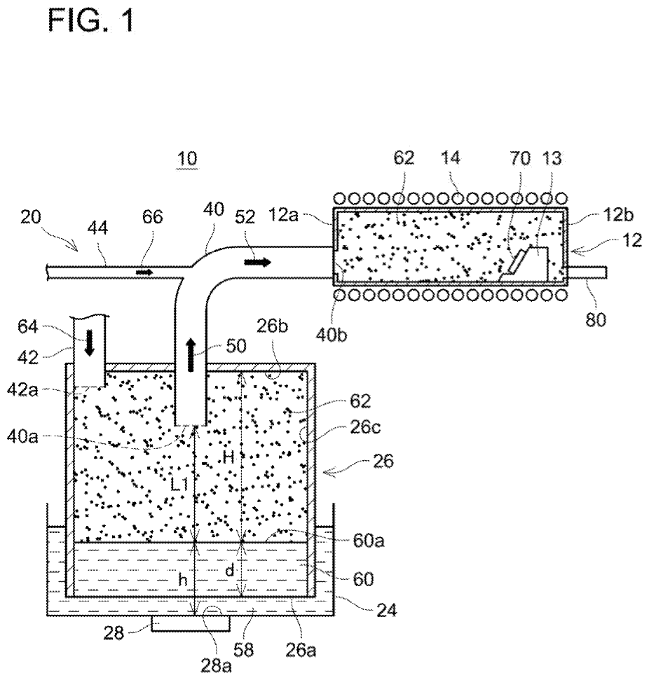

A film formation apparatus 10 shown in FIG. 1 is apparatus configured to epitaxially grow a film on a surface of a substrate 70. The film formation apparatus 10 includes a furnace 12 in which the substrate 70 is disposed, a heater 14 configured to heat the furnace 12, a mist generator 20 connected to the furnace 12, and an exhaust pipe 80 connected to the furnace 12.

The specific configuration of the furnace 12 is not particularly limited. As an example, the furnace 12 shown in FIG. 1 is a tubular furnace extending from an upstream end 12a to a downstream end 12b. A cross section of the furnace 12 perpendicular to its longitudinal direction has a circular shape. The cross section of the furnace 12 is not limited to the circular shape.

The mist generator 20 is connected to the upstream end 12a of the furnace 12. The downstream end 12b of the furnace 12 has the exhaust pipe 80 connected thereto. The mist generator 20 is configured to supply mist 62 into the furnace 12. The mist 62 supplied into the furnace 12 by the mist generator 20 flows in the furnace 12 to the downstream end 12b, and is then discharged to an outside of the furnace 12 via the exhaust pipe 80.

A substrate stage 13 for supporting the substrate 70 is arranged in the furnace 12. The substrate stage 13 is configured to incline the substrate 70 with respect to the longitudinal direction of the furnace 12. The substrate 70 is supported by the substrate stage 13 in an orientation that allows the mist 62 flowing in the furnace 12 from the upstream end 12a toward the downstream and 12b to be applied to the surface of the substrate 70.

As described above, the heater 14 is configured to heat the furnace 12. The specific configuration of the heater 14 is not particularly limited. As an example, the heater 14 shown in FIG. 1 is an electric heater, and is disposed along an outer peripheral wall of the furnace 12. The heater 14 heats the outer peripheral wall of the furnace 12, by which the substrate 70 in the furnace 12 is heated.

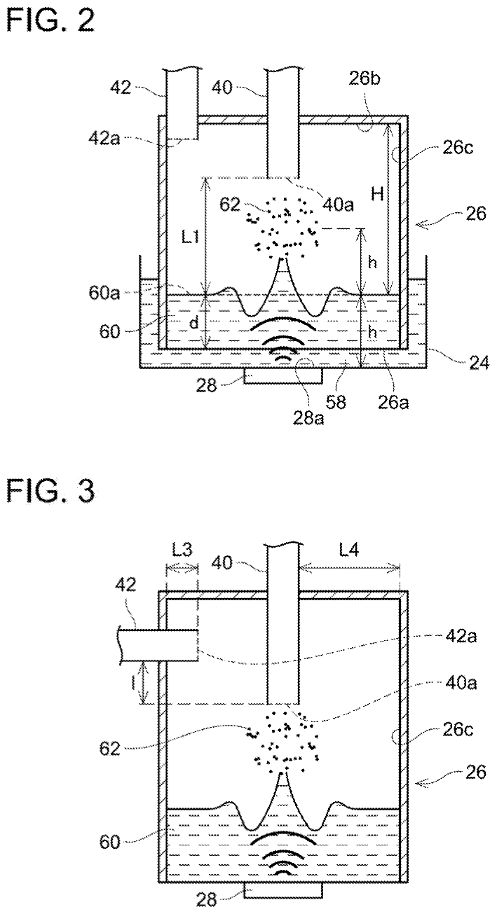

As shown in FIGS. 1 and 2, the mist generator 20 includes a water tank 24, a reservoir 26, and an ultrasonic vibrator 28. The water tank 24 is a container of which upper portion is opened, and stores water 58 therein. The ultrasonic vibrator 28 is arranged on a bottom surface of the water tank 24. A vibration surface 28a of the ultrasonic vibrator 28 is in contact with the bottom surface of the water tank 24. The ultrasonic vibrator 28 emits ultrasound from the vibration surface 28a and applies ultrasonic vibration to the water 58 in the water tank 24. The reservoir 26 is a closed container. The reservoir 26 stores a solution 60 that contains a raw material of a film to be epitaxially grown on the surface of the substrate 70. For example, if a gallium oxide (Ga₂O₃) film is to be epitaxially grown, a solution in which gallium is dissolved can be used as the solution 60. Moreover, a raw material for imparting an n-type or p-type dopant to the gallium oxide film (e.g., ammonium fluoride) may further be dissolved in the solution 60. An outer peripheral wall of the reservoir 26 has a cylindrical shape. The reservoir 26 has its bottom portion immersed in the water 58 in the water tank 24. A bottom surface 26a of the reservoir 26 is configured with a film. This facilitates transfer of the ultrasonic vibration from the water 58 in the water tank 24 to the solution 60 in the reservoir 26. When the ultrasonic vibrator 28 applies ultrasonic vibration to the water 58 in the water tank 24, the ultrasonic vibration is transferred to the solution 60 via the water 58. When this happens, a liquid surface 60a of the solution 60 vibrates as shown in FIG. 2, and the mist 62 of the solution 60 is thereby generated in a space above the solution 60 (i.e., a space in the reservoir 26).

The mist generator 20 further includes a mist delivery path 40, a carrier gas supply path 42, and a diluent gas supply path 44.

As shown in FIGS. 1 and 2, the mist delivery path 40 has its upstream side connected to an upper surface (i.e., a top plate) 26b of the reservoir 26. The mist delivery path 40 penetrates the upper surface 26b of the reservoir 26 and extends into the reservoir 26. Therefore, an upstream end (i.e., an inlet port 40a) of the mist delivery path 40 is positioned inside of the reservoir 26. The inlet port 40a is spaced from an inner lateral surface 26c of the reservoir 26. A downstream end (i.e., an outlet port 40b) of the mist delivery path 40 is connected to the upstream end 12a of the furnace 12. The mist delivery path 40 is configured to supply the mist 62 from the reservoir 26 to the furnace 12.

As shown in FIGS. 1 and 2, the carrier gas supply path 42 has its downstream side connected to the upper surface 26b of the reservoir 26. The carrier gas supply path 42 penetrates the upper surface 26b of the reservoir 26 and extends into the reservoir 26. Therefore, a downstream end (i.e., a discharge port 42a) of the carrier gas supply path 42 is positioned inside of the reservoir 26. The discharge port 42a is positioned above the inlet port 40a of the mist delivery path 40. Moreover, the discharge port 42a is disposed closer to the inner lateral surface 26c of the reservoir 26 than the inlet port 40a of the mist delivery path 40. An upstream end of the carrier gas supply path 42 is connected to a carrier gas supply source (not shown). The carrier gas supply path 42 is configured to supply carrier gas 64 from the carrier gas supply source to the reservoir 26. The carrier gas 64 is nitrogen gas or another inert gas. The carrier gas 64 is discharged from the discharge port 42a of the carrier gas supply path 42 into the reservoir 26. The carrier gas 64 discharged into the reservoir 26 flows into the mist delivery path 40 from the inlet port 40a. At this time, the mist 62 in the reservoir 26 flows into the mist delivery path 40 together with the carrier gas 64.

As shown in FIG. 1, the diluent gas supply path 44 has its downstream end connected to the mist delivery path 40 outside of the reservoir 26. The diluent gas supply path 44 has its upstream end connected to a diluent gas supply source (not shown). The diluent gas supply path 44 is configured to supply diluent gas 66 from the diluent gas supply source to the mist delivery path 40. The diluent gas 66 is nitrogen gas or another inert gas. The diluent gas 66 flowed into the mist delivery path 40 flows to the furnace 12 together with the mist 62 and the carrier gas 64. The diluent gas 66 dilutes the mist 62 in the mist delivery path 40.

Next, a film formation method using the film formation apparatus 10 will be described. Here, a substrate constituted of β-gallium oxide (β-Ga₂O₃) single crystal is used as the substrate 70. Moreover, an aqueous solution in which gallium chloride (GaCl₃, Ga₂Cl₆) and ammonium fluoride (NH₄F) are dissolved is used as the solution 60. Moreover, nitrogen gas is used both as the carrier gas 64 and as the diluent gas 66.

Firstly, the reservoir 26 that has stored the solution 60 therein is prepared. Here, the solution 60 is stored in the reservoir 26 such that each of the following relationships is satisfied. Specifically, as shown in FIG. 1, a relationship of d≤S^{0.5} is satisfied, where d is a depth of the solution 60 stored in the reservoir 26 (i.e., a distance from the bottom surface 26a of the reservoir 26 to the liquid surface 60a of the solution 60), and S (not shown) is an area of the liquid surface 60a of the solution 60 stored in the reservoir 26 (i.e., an area of a region within the inner lateral surface 26c of the reservoir 26 in a horizontal cross section of the reservoir 26). Moreover, a relationship of 2h≤H is satisfied, where h is a distance from the ultrasonic vibrator 28 to the liquid surface 60a, and H is a distance from the liquid surface 60a to the upper surface 26b of the reservoir 26. Furthermore, a relationship of h≤L1 is satisfied, where L1 is a distance from the liquid surface 60a to the inlet port 40a of the mist delivery path 40. Although the liquid level of the solution 60 changes while a film is formed, each of the above-described relationships is maintained until the film formation is completed on the surface of the substrate 70.

Next, the substrate 70 is placed on the substrate stage 13 in the furnace 12. Then, the substrate 70 is heated by the heater 14. Here, a temperature of the substrate 70 is controlled to be approximately 750° C. When the temperature of the substrate 70 becomes stable, the ultrasonic vibrator 28 is activated to generate the mist 62 of the solution 60 in the reservoir 26. A concentration of the mist 62 becomes stable at a certain height from the liquid surface 60a of the solution 60. Specifically, as shown in FIG. 2, the concentration of the mist 62 becomes stable at a height that is higher than the liquid surface 60a by a distance approximately equal to the distance h from the ultrasonic vibrator 28 to the liquid surface 60a of the solution 60 (i.e., at a height that is a distance of approximately h apart from the liquid surface 60a). After the concentration of the mist 62 generated in the reservoir 26 becomes stable, the carrier gas 64 is introduced from the carrier gas supply path 42 to the reservoir 26 and the diluent gas 66 is introduced from the diluent gas supply path 44 to the mist delivery path 40. As shown in FIG. 1, the carrier gas 64 passes through the reservoir 26 and then flows into the mist delivery path 40 from the inlet port 40a, as shown by an arrow 50. At this time, the mist 62 in the reservoir 26 flows into the mist delivery path 40 together with the carrier gas 64. The diluent gas 66 is mixed with the mist 62 in the mist delivery path 40, by which the mist 62 is diluted. Together with the nitrogen gas (i.e., the carrier gas 64 and the diluent gas 66), the mist 62 flows in the mist delivery path 40 toward the downstream side and flows into the furnace 12 from the outlet port 40b of the mist delivery path 40, as shown by an arrow 52. In the furnace 12, the mist 62 flows toward the downstream end 12b together with the nitrogen gas, and then is discharged from the exhaust pipe 80.

In the present embodiment, the flow rate of the carrier gas 64 is adjusted such that a relationship of (w1−w2)/w1≥0.1 is satisfied, where w1 is a weight of the mist 62 generated per unit time, and w2 is a weight of the mist 62 that flows into the inlet port 40a per unit time. Moreover, the flow rate of the carrier gas 64 is adjusted such that a relationship of (w1−w2)/w1≤0.7 is satisfied during a time period from the introduction of the carrier gas 64 to the completion of film formation on the surface of the substrate 70. In other words, a relationship 26 of 0.1≤(w1−w2)/w1≤0.7 is satisfied during the time period from the introduction of the carrier gas 64 to the completion of film formation on the surface of the substrate 70. Each of the above-described relationships can be adjusted by the flow rate of the carrier gas 64, operation power for the ultrasonic vibrator 28, for example. Each of the above-described relationships can also be adjusted by adjusting the position of the ultrasonic vibrator 28 on the bottom surface of the water tank 24.

A part of the mist 62 flowing in the furnace 12 adheres to the surface of the heated substrate 70. When this happens, the mist 62 (i.e., the solution 60) chemically reacts on the substrate 70. Consequently, β-gallium oxide (β-Ga₂O₃) is generated on the substrate 70. Since the mist 62 is continuously supplied to the surface of the substrate 70, a β-gallium oxide film is grown on the surface of the substrate 70. A single-crystal β-gallium oxide film is grown on the surface of the substrate 70. Since the solution 60 contains ammonium fluoride, the β-gallium oxide film is doped with fluorine.

In the film formation apparatus 10 of the present embodiment, the relationship of d≤S^{0.5} is established between the depth d of the stored solution 60 and the area S of the liquid surface of the stored solution 60. When such a relationship is satisfied, the liquid level (i.e., the depth d) of the solution 60 is less likely to vary in response to consumption (i.e., atomization) of the solution 60. Specifically, if the solution 60 stored in the reservoir 26 decreases by a volume P, a decrement Δd in the liquid level d of the solution 60 satisfies a relationship of Δd=P/S. Thus, the larger the area S is, the less likely the liquid level of the solution 60 varies. In the film formation apparatus 10 of the present embodiment, variations in the depth d is suppressed because the relationship of d≤S^{0.5} is satisfied. In other words, the distance h from the ultrasonic vibrator 28 to the liquid surface 60a of the solution 60 is less likely to vary. Thus, the height at which the concentration of the mist 62 in the reservoir 26 becomes stable (i.e., the height that is the distance of approximately h apart from the liquid surface 60a) is less likely to vary. That is, a relative positional relationship between the height at which the concentration of the mist 62 becomes stable and the inlet port 40a is less likely to change. Therefore, the concentration of the mist 62 that flows into the inlet port 40a is less likely to vary. Accordingly, the film formation apparatus 10 of the present embodiment can supply the mist 62 with stable concentration to the surface of the substrate 70.

Moreover, in the film formation apparatus 10 of the present embodiment, the relationship of 2h≤H is established between the distance h from the ultrasonic vibrator 28 to the liquid surface 60a of the solution 60 and the distance H from the liquid surface 60a of the solution 60 to the upper surface 26b of the reservoir 26. As described above, the concentration of the mist 62 becomes stable at the height that is the distance of approximately h apart from the liquid surface 60a. Satisfying the relationship of 2h≤H ensures the distance H from the liquid surface 60a to the upper surface 26b and suppresses adhesion of the generated mist 62 to the upper surface 26b of the reservoir 26 before the concentration of the mist 62 becomes stable. Therefore, the film formation apparatus 10 of the present embodiment does not interrupt an increase in the concentration of the mist 62 and thus can generate the mist 62 with high concentration in the reservoir 26.

Moreover, in the film formation apparatus 10 of the present embodiment, the relationship of h<L1 is established between the distance h and the distance L1 from the liquid surface 60a of the solution 60 to the inlet port 40a of the mist delivery path 40. In other words, the inlet port 40a is positioned above the height at which the concentration of the mist 62 becomes stable. Therefore, the film formation apparatus 10 of the present embodiment can supply the mist 62 with stable concentration into the mist delivery path 40 from the inlet port 40a.

Moreover, in the film formation apparatus 10 of the present embodiment, a relationship of L1<H is established between the distance L1 from the liquid surface 60a of the solution 60 to the inlet port 40a of the mist delivery path 40 and the distance H from the liquid surface 60a of the solution 60 to the upper surface 26b of the reservoir 26. In other words, the inlet port 40a is positioned below the upper surface 26b of the reservoir 26. Moreover, the inlet port 40a of the mist delivery path 40 is positioned to be spaced from the inner lateral surface 26c of the reservoir 26. When the mist reaches the upper surface 26b or the inner lateral surface 26c of the reservoir 26, it adheres to the upper surface 26b or the inner lateral surface 26c and thereby disappears. Therefore, in the reservoir 26, the concentration of the mist 62 is lower at positions closer to the upper surface 26b or the inner lateral surface 26c. In the film formation apparatus of the present embodiment, the inlet port 40a of the mist delivery path 40 is positioned to be spaced from the upper surface 26b and the inner lateral surface 26c of the reservoir 26, so the mist 62 with stable concentration can be supplied into the mist delivery path 40 from the inlet port 40a.

Moreover, in the film formation apparatus 10 of the present embodiment, the discharge port 42a of the carrier gas supply path 42 is positioned above the inlet port 40a of the mist delivery path 40. Furthermore, the discharge port 42a of the carrier gas supply path 42 is positioned closer to the inner lateral surface 26c of the reservoir 26 than the inlet port 40a of the mist delivery path 40. Arranging the discharge port 42a of the carrier gas supply path 42 closer to inner surfaces (i.e., the upper surface 26b and the inner lateral surface 26c) of the reservoir 26 than the inlet port 40a of the mist delivery path 40 as above can suppress the mist 62 flowing into the inlet port 40a from being disturbed by the flow of the carrier gas 64 introduced into the reservoir 26. In other words, changes in the concentration of the mist 62 to be supplied into the mist delivery path 40 from the inlet port 40a can be suppressed.

Moreover, in the film formation apparatus 10 of the present embodiment, the relationship of 0.1≤(w1−w2)/w1≤0.7 is satisfied during the time period from the introduction of the carrier gas 64 to the completion of film formation on the substrate 70. Here, (w1−w2)/w1 indicates a ratio of the mist 62 that remains in the reservoir 26 to the mist 62 generated per unit time. The present embodiment allows 10% or more of the generated mist 62 to remain in the reservoir 26. This remaining mist 62 can circulate in the reservoir 26, so the concentration of the mist 62 in the reservoir 26 is less likely to vary. Moreover, controlling an amount of the remaining mist 62 in the reservoir 26 to 70% or less of the generated mist 62 suppresses aggregation of particles of the mist 62 into oversized particles.

### Second Embodiment

A film formation apparatus of a second embodiment differs from the film formation apparatus 10 of the first embodiment in the configuration of the mist generator 20. The same applies to the other embodiments described later. As shown in FIG. 3, in the film formation apparatus of the second embodiment, the carrier gas supply path 42 is connected to a lateral surface of the reservoir 26. The carrier gas supply path 42 extends into the reservoir 26. A distance L3 from the inner lateral surface 26c of the reservoir 26 to the discharge port 42a of the carrier gas supply path 42 is shorter than a distance L4 from the inner lateral surface 26c of the reservoir 26 to the inlet port 40a of the mist delivery path 40. The discharge port 42a is positioned above the inlet port 40a by a distance l. Moreover, the ultrasonic vibrator 28 is disposed on the bottom surface 26a of the reservoir 26. In other words, unlike the first embodiment, the film formation apparatus of the second embodiment does not include the water tank 24. However, the film formation apparatus of the second embodiment may adopt the configuration that includes the water tank 24, as in the first embodiment. The same applies to the other embodiments described later. The other configurations of the film formation apparatus of the second embodiment are the same as those of the film formation apparatus 10 of the first embodiment.

In the film formation apparatus of the second embodiment, the carrier gas supply path 42 is connected to the lateral surface of the reservoir 26, unlike the first embodiment. In other words, the carrier gas supply path 42 extends horizontally within the reservoir 26. Even with such a configuration, the positional relationship between the inlet port 40a of the mist delivery path 40 and the discharge port 42a of the carrier gas supply path 42 (i.e., their height positions and distances from the inner lateral surface 26c) is similar to their relationship in the first embodiment, so similar effects to those of the first embodiment can be produced.

### Third Embodiment

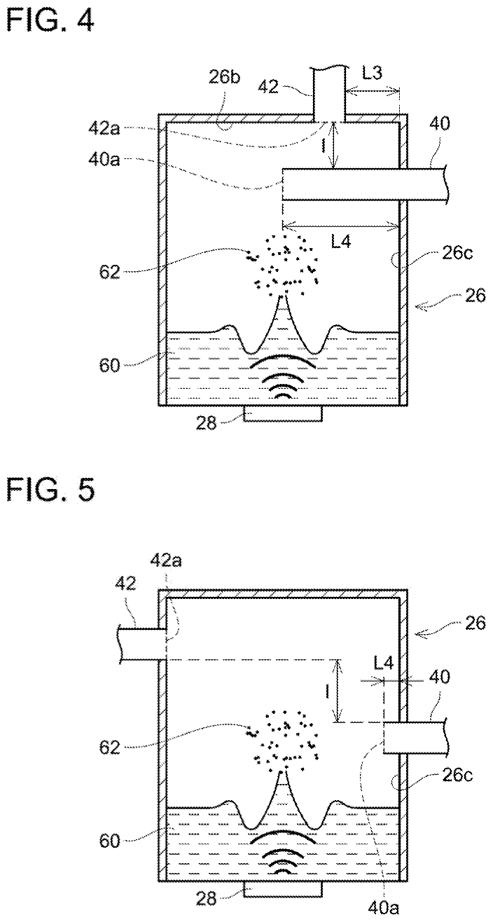

As shown in FIG. 4, in a film formation apparatus of a third embodiment, the mist delivery path 40 is connected to the lateral surface of the reservoir 26. The mist delivery path extends into the reservoir 26. The mist delivery path 40 extends up to a central position of the reservoir 26. Moreover, the carrier gas supply path 42 is connected to the upper surface 26b of the reservoir 26. The position of the discharge port 42a of the carrier gas supply path 42 substantially coincides with the position of the upper surface 26b of the reservoir 26. The distance L3 from the inner lateral surface 26c of the reservoir 26 to the discharge port 42a of the carrier gas supply path 42 is shorter than the distance L4 from the inner lateral surface 26c of the reservoir 26 to the inlet port 40a of the mist delivery path 40. The discharge port 42a is positioned above the inlet port 40a by the distance l. The other configurations of the film formation apparatus of the third embodiment are the same as those of the film formation apparatus 10 of the first embodiment.

In the film formation apparatus of the third embodiment, the mist delivery path 40 is connected to the lateral surface of the reservoir 26, unlike the first embodiment. In other words, the mist delivery path 40 extends horizontally within the reservoir 26. Even with such a configuration, the positional relationship between the inlet port 40a of the mist delivery path 40 and the discharge port 42a of the carrier gas supply path 42 is similar to their relationship in the first embodiment, so similar effects to those of the first embodiment can be produced.

### Fourth Embodiment

As shown in FIG. 5, in a film formation apparatus of a fourth embodiment, the mist delivery path 40 is connected to the lateral surface of the reservoir 26. The mist delivery path extends into the reservoir 26. Moreover, the carrier gas supply path 42 is also connected to the lateral surface of the reservoir 26. The position of the discharge port 42a of the carrier gas supply path 42 substantially coincides with the position of the inner lateral surface 26c of the reservoir 26. On the other hand, the inlet port 40a of the mist delivery path 40 is positioned inside of the reservoir 26 (at a position apart from the inner lateral surface 26c by the distance L4). The discharge port 42a is positioned above the inlet port 40a by the distance l. The other configurations of the film formation apparatus of the fourth embodiment are the same as those of the film formation apparatus 10 of the first embodiment.

In the film formation apparatus of the fourth embodiment, both the mist delivery path 40 and the carrier gas supply path 42 are connected to the lateral surface of the reservoir 26, unlike the first embodiment. Even with such a configuration, the positional relationship between the inlet port 40a of the mist delivery path 40 and the discharge port 42a of the carrier gas supply path 42 is similar to their relationship in the first embodiment, so similar effects to those of the 26 first embodiment can be produced.

### Fifth Embodiment

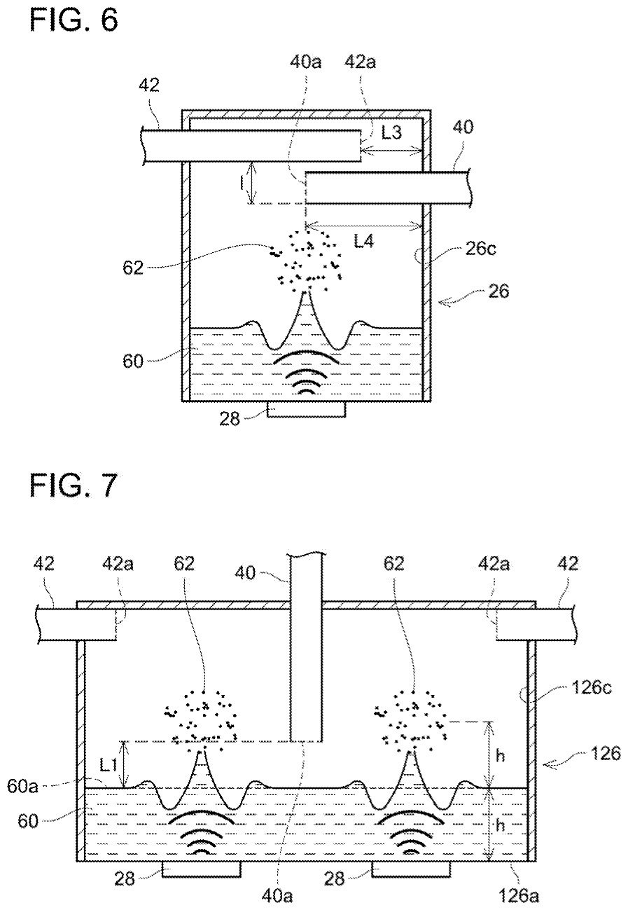

As shown in FIG. 6, in a film formation apparatus of a fifth embodiment, the mist delivery path 40 is connected to the lateral surface of the reservoir 26. The mist delivery path extends into the reservoir 26. The mist delivery path 40 extends up to the central position of the reservoir 26. Moreover, the carrier gas supply path 42 is also connected to the lateral surface of the reservoir 26. The carrier gas supply path 42 extends into the reservoir 26. The carrier gas supply path 42 extends up to a position beyond the central position of the reservoir 26. The distance L3 from the inner lateral surface 26c of the reservoir 26 to the discharge port 42a of the carrier gas supply path 42 is shorter than the distance L4 from the inner lateral surface 26c of the reservoir 26 to the inlet port 40a of the mist delivery path 40. It should be noted that the distance L3 herein mentioned is the shortest distance between the discharge port 42a and the inner lateral surface 26c as shown in FIG. 6, namely, a distance from the discharge port 42a to the inner lateral surface 26c located opposite to the surface to which the carrier gas supply path 42 is connected. The discharge port 42a is positioned above the inlet port 40a by the distance l. The other configurations of the film formation apparatus of the fifth embodiment are the same as those of the film formation apparatus 10 of the first embodiment.

In the film formation apparatus of the fifth embodiment, both the mist delivery path 40 and the carrier gas supply path 42 are connected to the lateral surface of the reservoir 26, unlike the first embodiment. Even with such a configuration, the positional relationship between the inlet port 40a of the mist delivery path 40 and the discharge port 42a of the carrier gas supply path 42 is similar to their relationship of the first embodiment, so similar effects to those of the first embodiment can be produced.

### Sixth Embodiment

As shown in FIG. 7, in a film formation apparatus of a sixth embodiment, the mist generator 20 includes a plurality of ultrasonic vibrators 28 (two ultrasonic vibrators 28 in the present embodiment). Each of the ultrasonic vibrators 28 is disposed on a bottom surface 126a of a reservoir 126. In a plan view of the reservoir 126 along a vertical direction, each of the ultrasonic vibrators 28 is disposed at a position that does not overlap with the inlet port 40a of the mist delivery path 40.

Moreover, in the film formation apparatus of the sixth embodiment, a plurality of carrier gas supply paths 42 (two carrier gas supply paths 42 in the present embodiment) is provided. Each of the carrier gas supply paths 42 is connected to a lateral surface of the reservoir 126. Each of the carrier gas supply paths 42 extends from an inner lateral surface 126c of the reservoir 126 into the reservoir 126. Each of the discharge ports 42a is positioned inside of the reservoir 126. Each of the discharge ports 42a is positioned above the inlet port 40a. Each of the discharge ports 42a is disposed closer to the inner lateral surface 126c of the reservoir 126 than the inlet port 40a. The distance L1 from the liquid surface 60a to the inlet port 40a is shorter than the distance h from each ultrasonic vibrator 28 to the liquid surface 60a. The other configurations of the film formation apparatus of the sixth embodiment are the same as those of the film formation apparatus 10 of the first embodiment.

As described above, when the ultrasonic vibrators 28 are activated, ultrasonic vibration is transferred to the solution 60 and the mist 62 is generated above the liquid surface 60a. As shown in FIG. 7, the mist 62 is generated in a narrow range directly above each of the ultrasonic vibrators 28. Including the plurality of ultrasonic vibrators 28, as in the present embodiment, can generate the mist 62 from a plurality of sites in the liquid surface 60a of the solution 60. The configuration of the present embodiment can suppress unevenness of the mist 62 generated in the space in the reservoir 126, and thus can suppress a non-uniform concentration of the mist 62.

Moreover, in the present embodiment, each of the ultrasonic vibrator 28 is disposed at the position that does not overlap with the inlet port 40a in the plan view of the reservoir 126. This suppresses the generated mist 62 from flowing directly into the inlet port 40a, and allows the generated mist 62 to circulate in the reservoir 126. The mist 62 with stable concentration can thus be supplied from the inlet port 40a into the mist delivery path 40. Especially in a case where a relationship of L15 h is satisfied as in the present embodiment, the generated mist 62 is more likely to flow directly into the inlet port 40a. Therefore, the above arrangement of the ultrasonic vibrators 28 is particularly useful when such a relationship is established.

Moreover, in the present embodiment, the plurality of carrier gas supply paths 42 is provided. In other words, the carrier gas 64 is introduced into the reservoir 26 from a plurality of sites. This can suppress an uneven flow of the carrier gas 64 in the reservoir 26 and thus can suppress a non-uniform concentration of the mist 62.

### Seventh Embodiment

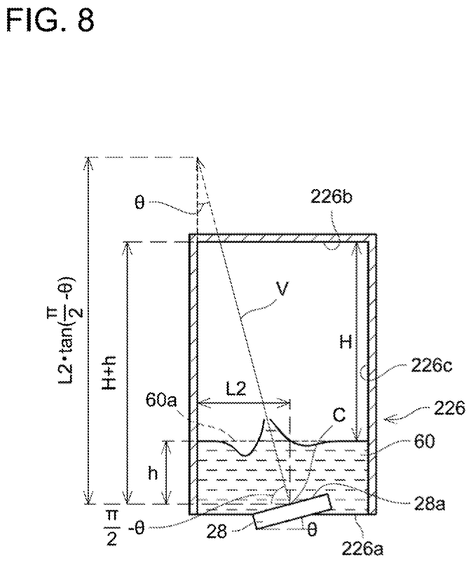

As shown in FIG. 8, in a film formation apparatus of a seventh embodiment, the ultrasonic vibrator 28 is inclined with respect to a reservoir 226. Specifically, a perpendicular line V to the vibration surface 28a of the ultrasonic vibrator 28 is inclined with respect to an inner lateral surface 226c of the reservoir 226 by an angle θ. As shown in FIG. 8, a relationship of H+h<L2·tan(π/2−θ) is established between a horizontal distance L2 and a distance H+h, where L2 is a horizontal distance from a center C of the vibration surface 28a to the inner lateral surface 226c located in a direction along which the perpendicular line V extends from the vibration surface 28a, and H+h is a distance from the center C of the vibration surface 28a of the ultrasonic vibrator 28 to an upper surface 226b of the reservoir 226 (i.e., a sum of the distance h from the ultrasonic vibrator 28 to the liquid surface 60a and the distance H from the liquid surface 60a to the upper surface 226b). Although FIG. 8 shows the ultrasonic vibrator 28 overlaps with a bottom surface 226a of the reservoir 226, this depiction is merely for easy description and understanding, and the ultrasonic vibrator 28 is actually located below the bottom surface of the reservoir 226.

The vibration surface 28a of the ultrasonic vibrator 28 may be inclined with respect to the reservoir 226 as in the present embodiment, in order to efficiently generate the mist 62. In this case, as shown in FIG. 8, the mist 62 is ejected from the liquid surface 60a in a direction inclined with respect to the liquid surface 60a by an angle π/2−θ (in a direction of the perpendicular line V). Thus, the ejected mist 62 reaches and adheres to the inner lateral surface 226c at a height of L2·tan(π/2−θ) from the center C of the vibration surface 28a. Therefore, even if the reservoir 226 has an internal space above that height, the mist 62 is less likely to reach the space. If the reservoir 226 has a space that the mist 62 does not reach, a long time is required to reach a saturated vapor pressure of the solution 60, and the particle size and/or concentration of the mist 62 would be more likely to vary. In the present embodiment, however, the distance H+h from the center C of the vibration surface 28a to the upper surface 226b of the reservoir 226 is shorter than L2·tan(π/2−θ). The reservoir 226 is therefore easily filled with the mist 62, and the mist 62 with stable concentration can be supplied. In a case where a plurality of ultrasonic vibrators 28 is disposed, the height of the reservoir 226 simply needs to be set such that the above-described relationship is satisfied for each of the ultrasonic vibrators 28.

Some of the features characteristic to the technology disclosed herein will be listed below. It should be noted that the respective technical elements are independent of one another, and are useful solely or in combinations.

In a configuration disclosed herein as an example, the ultrasonic vibrator may be provided under the reservoir. A relationship of 2h≤H may be satisfied, where h is a distance from the ultrasonic vibrator to the liquid surface of the solution and H is a distance from the liquid surface of the solution to an upper surface of the reservoir.

Such a configuration ensures the distance H from the liquid surface of the solution to the upper surface of the reservoir, and hence suppresses the generated mist from adhering to the upper surface of the reservoir before the concentration of the mist becomes stable. This does not interrupt an increase in the concentration of the mist and can generate the mist with stable concentration.

In a configuration disclosed herein as an example, a relationship of h≤L1 may be satisfied, where L1 is a distance from the liquid surface of the solution to an inlet port of the mist delivery path.

The concentration of the mist becomes stable at a height that is above the liquid surface by a distance approximately equal to the distance h from the ultrasonic vibrator to the liquid surface of the solution. In the above-described configuration, the inlet port is positioned above the height at which the concentration of the mist becomes stable. The mist with stable concentration can therefore be supplied into the mist delivery path from the inlet port.

In a configuration disclosed herein as an example, a relationship of L1<H may be satisfied, where H is a distance from the liquid surface of the solution to an upper surface of the reservoir and L1 is a distance from the liquid surface of the solution to an inlet port of the mist delivery path.

In such a configuration, the inlet port is positioned below the upper surface of the reservoir. When the mist reaches the upper surface of the reservoir, it adheres to the upper surface and thereby disappears. Therefore, within the reservoir, the concentration of the mist is lower at positions closer to the upper surface of the reservoir. In the above-described configuration, however, the inlet port of the mist delivery path is positioned at a position spaced from the upper surface of the reservoir, so the mist with stable concentration can be supplied into the mist delivery path from the inlet port.

In a configuration disclosed herein as an example, the ultrasonic vibrator may comprise a plurality of ultrasonic vibrators.

The mist is generated in a narrow range directly above each of the ultrasonic vibrators. With the plurality of ultrasonic vibrators, the mist can be generated from a plurality of sites in the liquid surface of the solution. The above-described configuration can therefore suppress unevenness of the mist generated in the space in the reservoir, and can suppress a non-uniform concentration of the mist.

In a configuration disclosed herein as an example, in a plan view of the reservoir along a vertical direction, the ultrasonic vibrator may be disposed at a position that does not overlap with an inlet port of the mist delivery path.

Such a configuration can suppress the generated mist from flowing directly into the inlet port and enables the generated mist to circulate in the reservoir. Therefore, the mist with stable concentration can be supplied into the mist delivery path from the inlet port.

In a configuration disclosed herein as an example, an inlet port of the mist delivery path may be spaced from an inner lateral surface of the reservoir.

When the mist reaches the inner lateral surface of the reservoir, it adheres to the inner lateral surface and thereby disappears. Therefore, within the reservoir, the concentration of the mist is lower at positions closer to the inner lateral surface. In the above-described configuration, however, the inlet port of the mist delivery path is positioned at a position spaced from the inner lateral surface of the reservoir, so the mist with stable concentration can be supplied into the mist delivery path from the inlet port.

In a configuration disclosed herein as an example, the mist generator may further comprise a carrier gas supply path configured to discharge carrier gas into the reservoir. A discharge port of the carrier gas supply path may be positioned above an inlet port of the mist delivery path.

Such a configuration can suppress the mist flowing in from the inlet port from being disturbed by the flow of the carrier gas introduced into the reservoir. In other words, the configuration can suppress changes in the concentration of the mist supplied into the mist delivery path from the inlet port.

In a configuration disclosed herein as an example, the discharge port of the carrier gas supply path may be positioned closer to an inner lateral surface of the reservoir than the inlet port of the mist delivery path.

Such a configuration can suppress the mist flowing in from the inlet port from being disturbed by the flow of the carrier gas introduced into the reservoir. In other words, this configuration can suppress changes in the concentration of the mist supplied into the mist delivery path from the inlet port.

In a configuration disclosed herein as an example, the discharge port of the carrier gas supply path may comprise a plurality of discharge ports.

In such a configuration, the carrier gas is introduced into the reservoir from a plurality of sites. This suppresses an uneven flow of the carrier gas in the reservoir, and can suppress a non-uniform concentration of the mist.

In a configuration disclosed herein as an example, a perpendicular line to a vibration surface of the ultrasonic vibrator may be inclined with respect to an inner lateral surface of the reservoir. A relationship of H+h≤L2·tan(π/2−θ) may be satisfied, where θ is an angle between the perpendicular line and the inner lateral surface and L2 is a horizontal distance from a center of the vibration surface to the inner lateral surface located in a direction along which the perpendicular line extends from the vibration surface.

In such a configuration, the mist can be efficiently generated because the ultrasonic vibrator is inclined. The mist is ejected from the liquid surface in a direction inclined with respect to the liquid surface by an angle π/2−θ. Therefore, the ejected mist reaches and adheres to the inner lateral surface at a height of L2·tan(x/2−θ) from the center of the vibration surface. In the above-described configuration, the upper surface of the reservoir is positioned at a lower position than the aforementioned height. The reservoir is therefore easily filled with the mist, and the mist with stable concentration can be supplied.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A mist generator comprising:
a reservoir storing a solution;
an ultrasonic vibrator configured to apply ultrasonic vibration to the solution stored in the reservoir to generate mist of the solution in the reservoir; and
a mist delivery path configured to deliver the mist from an inside of the reservoir to an outside of the reservoir,
wherein
a relationship of d≤S^{0.5} is satisfied, where d is a depth of the solution stored in the reservoir and S is an area of a liquid surface of the solution stored in the reservoir.

2. The mist generator of claim 1, wherein
the ultrasonic vibrator is provided under the reservoir, and
a relationship of 2h≤H is satisfied, where h is a distance from the ultrasonic vibrator to the liquid surface of the solution and H is a distance from the liquid surface of the solution to an upper surface of the reservoir.

3. The mist generator of claim 2, wherein
a relationship of h≤L1 is satisfied, where L1 is a distance from the liquid surface of the solution to an inlet port of the mist delivery path.

4. The mist generator of claim 3, wherein
a relationship of L1<H is satisfied.

5. The mist generator of claim 1, wherein
the ultrasonic vibrator comprises a plurality of ultrasonic vibrators.

6. The mist generator of claim 1, wherein
in a plan view of the reservoir along a vertical direction, the ultrasonic vibrator is disposed at a position that does not overlap with an inlet port of the mist delivery path.

7. The mist generator of claim 1, wherein
an inlet port of the mist delivery path is spaced from an inner lateral surface of the reservoir.

8. The mist generator of claim 1, further comprising:
a carrier gas supply path configured to discharge carrier gas into the reservoir,
wherein
a discharge port of the carrier gas supply path is positioned above an inlet port of the mist delivery path.

9. The mist generator of claim 8, wherein
the discharge port of the carrier gas supply path is positioned closer to an inner lateral surface of the reservoir than the inlet port of the mist delivery path.

10. The mist generator of claim 8, wherein
the discharge port of the carrier gas supply path comprises a plurality of discharge ports.

11. The mist generator of claim 1, wherein
a perpendicular line to a vibration surface of the ultrasonic vibrator is inclined with respect to an inner lateral surface of the reservoir, and
a relationship of H+h<L2·tan(π/2−θ) is satisfied, where θ is an angle between the perpendicular line and the inner lateral surface and L2 is a horizontal distance from a center of the vibration surface to the inner lateral surface located in a direction along which the perpendicular line extends from the vibration surface.

12. A film formation apparatus comprising:
the mist generator of claim 1; and
a furnace configured to house a substrate so as to heat the substrate,
wherein
an outlet port of the mist delivery path is connected to the furnace, and
the film formation apparatus supplies the mist of the solution to a surface of the substrate to grow a film on the surface of the substrate.
